(19) United States
(12) Patent Application Publication
(10) Pub. No.: US 2026/0192531 A1
(43) Pub. Date: Jul. 9, 2026

(54) MANUFACTURING DEVICE FOR HIGH-PRESSURE TANK

(71) Applicant: TOYOTA JIDOSHA KABUSHIKI KAISHA, Toyota-shi (JP)

(72) Inventor: Ken HATTA, Toyota-shi (JP)

(73) Assignee: TOYOTA JIDOSHA KABUSHIKI KAISHA, Toyota-shi (JP)

(21) Appl. No.: 19/364,200

(22) Filed: Oct. 21, 2025

(30) Foreign Application Priority Data
Jan. 9, 2025 (JP) 2025-003539

(51) Int. Cl. B29C 70/68; B29L 31/00

(52) U.S. Cl. CPC B29C 70/682; B29C 2791/008; B29L 2031/7156

(57) ABSTRACT

A manufacturing device for manufacturing a high-pressure tank includes a resin tank that stores resin, and a resin impregnation promotion device that promotes impregnation of a fiber layer of a preform that is immersed in the resin in the resin tank, by the resin that is in the resin tank.

### CROSS-REFERENCE TO RELATED APPLICATION

This application claims priority to Japanese Patent Application No. 2025-003539 filed on January 9, 2025. The disclosure of the above-identified application, including the specification, drawings, and claims, is incorporated by reference herein in its entirety.

### BACKGROUND

### 1.Technical Field

The technology that is disclosed in the present specification relates to a manufacturing device for a high-pressure tank.

### 2. Description of Related Art

Japanese Unexamined Patent Application Publication No. 2021-154639 (JP 2021-154639 A) discloses a manufacturing method for a high-pressure tank. The manufacturing method in JP 2021-154639 includes a process of impregnating a fiber layer of a preform with a curable resin and performing curing thereof.

### SUMMARY

In the manufacturing method of JP 2021-154639 A, there is a concern that the fiber layer of the preform may not be suitably impregnated with the curable resin. The present specification provides technology that can promote impregnation of the fiber layer of the preform with the resin.

According to a first aspect of the present technology, a manufacturing device for a high-pressure tank includes a resin tank that stores resin, and a resin impregnation promotion device that promotes impregnation of a fiber layer of a preform that is immersed in the resin in the resin tank, by the resin in the resin tank.

According to this configuration, providing the resin impregnation promotion device enables impregnation of the fiber layer of the preform by the resin to be promoted.

According to a second aspect, in the first aspect, the resin impregnation promotion device may include a stirring device that stirs the resin in the resin tank.

According to a third aspect, in the first aspect, the resin impregnation promotion device may include a vibration generating device that vibrates the preform that is immersed in the resin in the resin tank.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a high-pressure tank according to an embodiment;

FIG. 2 is a cross-sectional view taken along line II-II in FIG. 1;

FIG. 3 is a cross-sectional view of a manufacturing device for the high-pressure tank, according to the embodiment; and

FIG. 4 is a cross-sectional view of the manufacturing device for the high-pressure tank according to a modification.

### DETAILED DESCRIPTION OF EMBODIMENTS

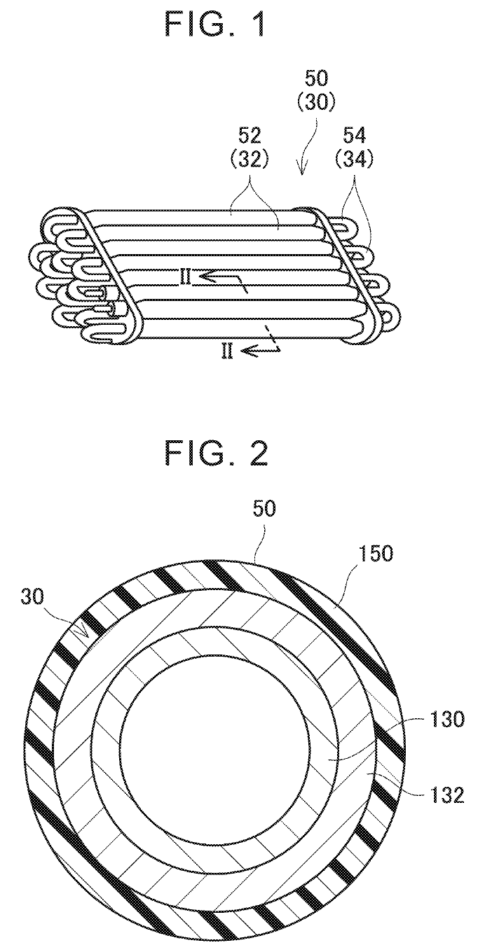

A high-pressure tank 50 according to an embodiment will be described with reference to the drawings. The high-pressure tank 50 of the embodiment is manufactured by a manufacturing device 2 that will be described later. As illustrated in FIG. 1, the high-pressure tank 50 includes a plurality of tank portions 52 and a plurality of linking portions 54. This high-pressure tank 50 is capable of storing hydrogen in a high-pressure state.

The tank portions 52 of the high-pressure tank 50 are disposed in a stacked manner. The tank portions 52 are stacked in a plurality of layers. The tank portions 52 are linked by the linking portions 54. Each of the tank portions 52 is capable of storing hydrogen in a high-pressure state. Each of the linking portions 54 is also capable of storing hydrogen in a high-pressure state. Interiors of the tank portions 52 and interiors of the tank portions 52 that are linked by the linking portions 54 communicate with each other through interiors of the linking portions 54.

As illustrated in FIG. 2, the high-pressure tank 50 includes a preform 30 and a resin layer 150 that covers the preform 30. The resin layer 150 is provided around the preform 30. The preform 30 will be described later. The type of resin that is contained in the resin layer 150 is not limited in particular. The resin layer 150 contains an epoxy resin, for example. The resin layer 150 may contain a curing agent that cures the resin. Gaps between fibers that are contained in a fiber layer 132 of the preform 30 are impregnated by resin that is contained in the resin layer 150. The high-pressure tank 50 is manufactured by the manufacturing device 2 that will be described later, using the preform 30.

Next, the preform 30 will be described. The preform 30 is an intermediate member that will ultimately become the high-pressure tank 50. Accordingly, the preform 30 includes a configuration corresponding to the high-pressure tank 50. Hence, the configuration of the preform 30 will be described with reference numerals relating to the preform 30 being added in parentheses to the drawings describing the high-pressure tank 50.

As illustrated in FIG. 1, the preform 30 includes a plurality of tank portions 32 and a plurality of linking portions 34. The tank portions 32 of the preform 30 are portions that will ultimately become the tank portions 52 of the high-pressure tank 50, and the linking portions 34 of the preform 30 are portions that will ultimately become the linking portions 54 of the high-pressure tank 50.

The tank portions 32 of the preform 30 are disposed in a stacked manner. The tank portions 32 are stacked in a plurality of layers. The tank portions 32 are linked by the linking portions 34. Each of the tank portions 32 is capable of storing hydrogen in a high-pressure state. Each of the linking portions 34 is also capable of storing hydrogen in a high-pressure state. Interiors of the tank portions 32 and interiors of the tank portions 32 that are linked by the linking portions 34 communicate with each other through interiors of the linking portions 34.

As illustrated in FIG. 2, the preform 30 includes a liner 130 and the fiber layer 132 that is wrapped around the liner 130. The liner 130 is a hollow member that defines interior space of the high-pressure tank 50. It is sufficient for the liner 130 to be made of a material that can retain the high-pressure hydrogen that is accommodated in the interior space thereof without leaking, and known materials may be used. The liner 130 is made of, for example, nylon resin, polyethylene-based synthetic resin, stainless steel, aluminum alloy, or the like. The thickness of the liner 130 is, for example, 0.5 mm to 1.0 mm, although not limited thereto in particular.

The fiber layer 132 is wrapped around an outer peripheral face of the liner 130. The type of fiber that is contained in the fiber layer 132 is not limited in particular. The fiber layer 132 includes, for example, one or a plurality of types of fibers selected from carbon fibers, resin fibers, glass fibers, and metal fibers.

Next, the manufacturing device 2 for manufacturing the high-pressure tank 50 will be described with reference to the drawings. The manufacturing device 2 according to the embodiment is a device for manufacturing the high-pressure tank 50 from the preform 30. This manufacturing device 2 manufactures the high-pressure tank 50 by impregnating the fibers of the fiber layer 132 of the preform 30 with resin.

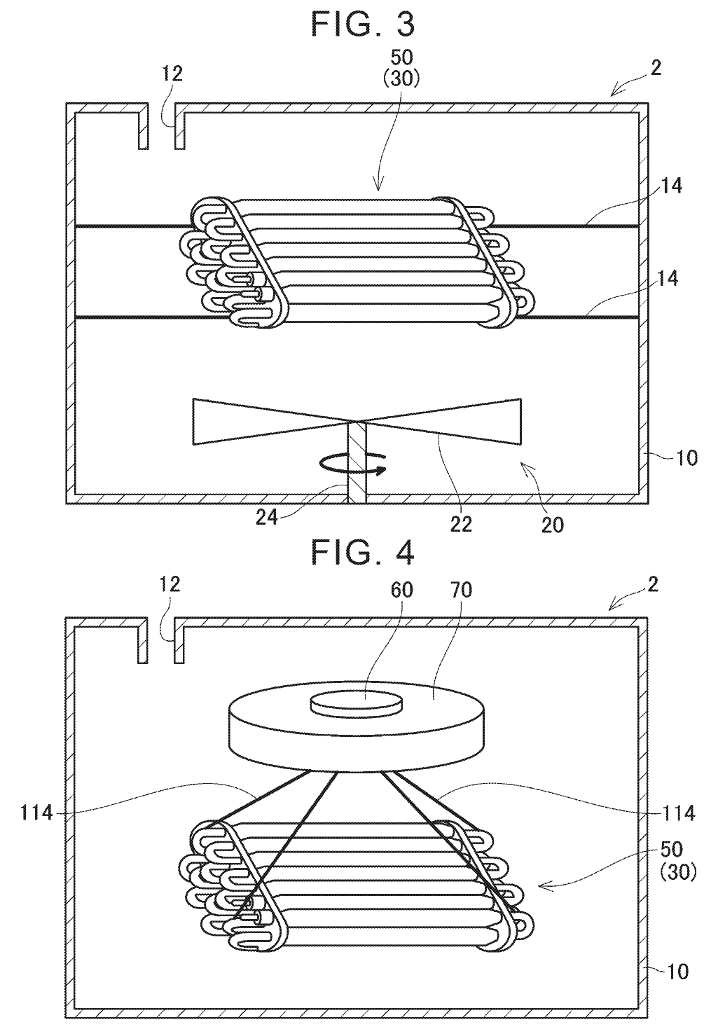

As illustrated in FIG. 3, the manufacturing device 2 includes a resin tank 10 and a stirring device 20. The resin tank 10 stores resin, which is the material of the resin layer 150 of the high-pressure tank 50. The type of resin that is stored in the resin tank 10 is not limited in particular. For example, epoxy resin is stored in the resin tank 10.

The resin tank 10 includes one or a plurality of support members 14 that supports the preform 30 within the resin tank 10. The support members 14 support the preform 30 in a state in which the preform 30 is being immersed in the resin in the resin tank 10.

The stirring device 20 includes a stirring blade 22 and a rotating shaft 24. The stirring device 20 is attached to a bottom portion of the resin tank 10. The stirring blade 22 and the rotating shaft 24 are rotated by driving of a motor that is omitted from illustration. The stirring device 20 stirs the resin in the resin tank 10 by rotating the stirring blade 22 and the rotating shaft 24. The stirring device 20 stirs the resin in the resin tank 10 in a state in which the preform 30 is immersed in the resin in the resin tank 10. The stirring device 20 stirs the resin in the resin tank 10 to promote impregnation of the fiber layer 132 of the preform 30 by the resin. The gaps between the fibers of the fiber layer 132 of the preform 30 are impregnated by the resin in the resin tank 10.

The resin tank 10 may be provided with a degassing hole 12 for degassing any gas within the resin tank 10. The manufacturing device 2 may be equipped with a degassing device (omitted from illustration) that degasses any gas in the resin tank 10 through the degassing hole 12.

The manufacturing device 2 for the high-pressure tank 50 according to the embodiment has been described above. It is clear from the above description that the manufacturing device 2 includes the resin tank 10 for storing resin, and the stirring device 20 (an example of a resin impregnation promotion device) for promoting impregnation of the fiber layer 132 of the preform 30 that is immersed in the resin in the resin tank 10, by the resin in the resin tank 10. According to this configuration, stirring the resin in the resin tank 10 enables promotion of impregnation of the fiber layer 132 of the preform 30 by the resin.

### Modifications

As illustrated in FIG. 4, the manufacturing device 2 according to a modification includes a vibration generating device 60 that is disposed within the resin tank 10. Also, the manufacturing device 2 according to the modification includes a rotating device 70 that is disposed in the resin tank 10. The vibration generating device 60 and the rotating device 70 are integrally configured. The vibration generating device 60 and the rotating device 70 may move up and down within the resin tank 10.

The rotating device 70 includes one or a plurality of support members 114 that supports the preform 30 within the resin tank 10. The support members 114 support the preform 30 in a state in which the preform 30 is being immersed in the resin in the resin tank 10. The rotating device 70 rotates the preform 30 in a state in which the preform 30 is being supported by the support members 114. The rotating device 70 rotates the preform 30 by being driven by a motor that is omitted from illustration.

The vibration generating device 60 vibrates the preform 30 in a state in which the preform 30 is being supported by the support members 114. The vibration generating device 60 vibrates the preform 30 by driving a motor that is omitted from illustration. The vibration generating device 60 vibrates the preform 30 to promote the impregnation of the fiber layer 132 of the preform 30 by the resin. The gaps between the fibers of the fiber layer 132 of the preform 30 are impregnated by the resin in the resin tank 10.

The manufacturing device 2 for the high-pressure tank 50 according to the modification has been described above. It is clear from the above description that the manufacturing device 2 is equipped with the vibration generating device 60 (an example of a resin impregnation promotion device) that promotes the impregnation of the fiber layer 132 of the preform 30 that is immersed in the resin in the resin tank 10 with the resin in the resin tank 10. According to this configuration, vibrating the preform 30 enables promotion of impregnation of the fiber layer 132 of the preform 30 by the resin.

While specific examples of the present disclosure have been described in detail above, these are merely examples and do not limit the scope of the claims. The technology described in the claims includes various modifications and variations of the specific examples exemplified above. The technical elements that are described in this specification or drawings exhibit technical utility either alone or in various combinations, and are not limited to the combinations that are described in the claims at the time of filing. Furthermore, the technology that is exemplified in the present specification or the drawings can achieve multiple objectives simultaneously, and achieving any one of these objectives is itself technically useful.

What is claimed is:

1. A manufacturing device for a high-pressure tank, the manufacturing device comprising:
a resin tank that stores resin; and
a resin impregnation promotion device that promotes impregnation of a fiber layer of a preform that is immersed in the resin in the resin tank, by the resin in the resin tank.

2. The manufacturing device according to claim 1, wherein the resin impregnation promotion device includes a stirring device that stirs the resin in the resin tank.

3. The manufacturing device according to claim 1, wherein the resin impregnation promotion device includes a vibration generating device that vibrates the preform that is immersed in the resin in the resin tank.
